(19) United States
(12) Patent Application Publication
(10) Pub. No.: US 2024/0095884 A1
(43) Pub. Date: Mar. 21, 2024

(54) Systems and Methods for Film Grain Synthesis and Insertion

(71) Applicant: Apple Inc., Cupertino, CA (US)

(72) Inventors: Shereef Shehata, San Ramon, CA (US); Stephan Lachowsky, San Francisco, CA (US); Jim C Chou, San Jose, CA (US)

(21) Appl. No.: 17/946,899

(22) Filed: Sep. 16, 2022

(51) Int. Cl. G06T 5/00; G06T 3/40

(52) U.S. Cl. CPC G06T 5/002; G06T 3/40; G06T 2207/20204

(57) ABSTRACT

Systems and methods are provided for adding digital film grain to images and videos displayed by a display of an electronic device. An image processing circuitry of the electronic device may include hardware, such as display pipeline hardware, memory-to-memory scaler and rotator (MSR) hardware, and/or other possible hardware, that enables generation of film grain templates based on characteristics of a target film grain, pseudo-randomly samples the programmable template to fetch film grain values, scales the film grain values, and combines the scaled film grain values with values of pixels in an image frame.

### BACKGROUND

This disclosure relates to systems and methods for synthesizing and inserting realistic film grains into image content on an electronic device.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Images that are recorded on film may often have a random optical texture called film grain. On the other hand, digitally recorded images typically do not have film grain. In certain cases, it may be desirable to add film grain to digitally recorded images or video. For example, adding film grain to a video may make the video appear cinematic. Yet digitally recorded images or videos that have been altered to include a digital film grain effect may often appear artificial or unrealistic. Moreover, adding digital film grain effects to digitally recorded image or video may increase the bit rate associated with the image or video.

### SUMMARY

A summary of certain embodiments disclosed herein is set forth below. It should be understood that these aspects are presented to provide the reader with a brief summary of these certain embodiments and that these aspects are not intended to limit the scope of this disclosure.

It may be desirable for certain images and videos to appear to have been recorded on film rather than digitally. Images and videos that are recorded on film often appear to have film grain. Yet, a digitally recorded video that has been altered to include a digital film grain effect may often appear artificial or unrealistic. Moreover, due to its spatiotemporal randomness, film grain may be difficult to preserve after encoding. Thus, film grain may be removed from a video or an image before encoding and added after decoding. It is presently recognized that improving the systems and methods for adding digital film grain to images and videos may improve the quality and ease with which such cinematic effects may be added such media.

Accordingly, the embodiments of the present disclosure are directed to a system and methods that enable adding realistic digital film grain to images and videos. In an embodiment, the system may include image processing hardware, such as display pipeline hardware, memory-to-memory scaler and rotator (MSR) hardware, and/or any other suitable image processing hardware of the electronic device, that generates programmable templates that include the film grain “pattern” of a target film grain, pseudo-randomly samples the programmable templates to fetch film grain values, scales the film grain values, and combines the scaled film grain values with values of pixels in an image frame. In an embodiment, the methods may include a parametric method of generating the programmable template, which involves determining a set of parameters, such as parameters of an autoregressive model that characterize the film grain of a sample image and generating a programmable template based on the set of parameters. Additionally or an alternatively, the methods may include a spectral method of generating the programmable template, which involves generating a programmable template with pixel values that have a target spatial frequency spectrum and a target correlation structure.

### BRIEF DESCRIPTION OF THE DRAWINGS

Various aspects of this disclosure may be better understood upon reading the following detailed description and upon reference to the drawings described below.

FIG. 1 is a block diagram of an electronic device with an electronic display, in accordance with an embodiment;

FIG. 2 is an example of the electronic device of FIG. 1, in accordance with an embodiment;

FIG. 3 is another example of the electronic device of FIG. 1, in accordance with an embodiment;

FIG. 4 is another example of the electronic device of FIG. 1, in accordance with an embodiment;

FIG. 5 is another example of the electronic device of FIG. 1, in accordance with an embodiment;

FIG. 6 is a block diagram of memory-to-memory scaler and rotator hardware for image processing, in accordance with an embodiment;

FIG. 7 is a is a block diagram of film grain insertion circuitry, in accordance with an embodiment;

FIG. 8 is a flow diagram of a process of generating a programmable template via a parametric method and sampling the programmable template to retrieve the film grain value, in accordance with an embodiment;

FIG. 9 is an illustration of a programmable template generated via the parametric method and the corresponding film grain sample, in accordance with an embodiment; and

FIG. 10 is a flow diagram of a process of generating a programmable template via a spectral method and of sampling the programmable template to retrieve film grain value, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “some embodiments,” “embodiments,” “one embodiment,” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

This disclosure relates to image processing hardware that enables efficiently adding digital film grain to images and videos. The image processing hardware may include hardware, such as display pipeline hardware, memory-to-memory scaler and rotator (MSR) hardware, and/or any other suitable image processing hardware of an electronic device, that generates programmable templates that include the film grain “pattern” of a target film grain, pseudo-randomly samples the programmable templates to fetch film grain values, scales the film grain values, and combines the scaled film grain values with values of pixels in an image frame of the image and/or video. In addition, the image processing hardware may include hardware that generates the programmable templates via a parametric method, which involves determining a set of parameters, such as parameters of an autoregressive model, that characterize the film grain of a sample image and generating a programmable template based on the set of parameters. Additionally or alternatively, the image processing hardware may include hardware that generates the programmable templates via a spectral method, which involves generating a programmable template with pixel values that have a target spatial frequency spectrum and a target correlation structure.

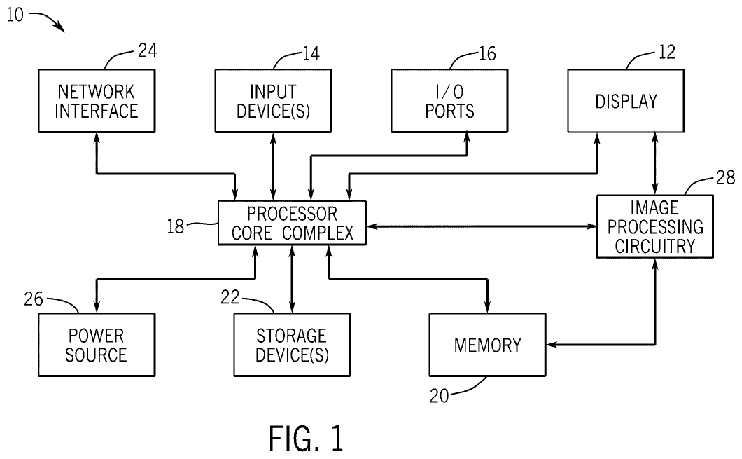

With the foregoing in mind, an electronic device 10 including an electronic display 12 (e.g., display device) is shown in FIG. 1. As is described in more detail below, the electronic device 10 may be any suitable electronic device, such as a computer, a mobile phone, a portable media device, a tablet, a television, a virtual-reality headset, a vehicle dashboard, and the like. Thus, it should be noted that FIG. 1 is merely one example of a particular implementation and is intended to illustrate the types of components that may be present in an electronic device 10.

The electronic display 12 may be any suitable electronic display. For example, the electronic display 12 may include a self-emissive pixel array having an array of one or more of self-emissive pixels. The electronic display 12 may include any suitable circuitry to drive the self-emissive pixels, including for example row driver and/or column drivers (e.g., display drivers). Each of the self-emissive pixels may include any suitable light emitting element, such as a LED, one example of which is an organic light-emitting diode (OLED). However, any other suitable type of pixel, including non-self-emissive pixels (e.g., liquid crystal as used in liquid crystal displays (LCDs), digital micromirror devices (DMD) used in DMD displays) may also be used.

In the depicted embodiment, the electronic device 10 includes the electronic display 12, one or more input devices 14, one or more input/output (I/O) ports 16, a processor core complex 18 having one or more processor(s) or processor cores, local memory 20, a main memory storage device 22, a network interface 24, a power source 26 (e.g., power supply), and image processing circuitry 28. The various components described in FIG. 1 may include hardware elements (e.g., circuitry), software elements (e.g., a tangible, non-transitory computer-readable medium storing instructions), or a combination of both hardware and software elements. It should be noted that the various depicted components may be combined into fewer components or separated into additional components. For example, the local memory 20 and the main memory storage device 22 may be included in a single component. The image processing circuitry 28 (e.g., a graphics processing unit) may be included in or separate from the processor core complex 18.

The processor core complex 18 may execute instruction stored in local memory 20 and/or the main memory storage device 22 to perform operations, such as generating and/or transmitting image data. As such, the processor core complex 18 may include one or more general purpose microprocessors, one or more application specific integrated circuits (ASICs), one or more field programmable gate arrays (FPGAs), or any combination thereof.

In addition to instructions, the local memory 20 and/or the main memory storage device 22 may store data to be processed by the processor core complex 18. Thus, the local memory 20 and/or the main memory storage device 22 may include one or more tangible, non-transitory, computer-readable mediums. For example, the local memory 20 may include random access memory (RAM) and the main memory storage device 22 may include read-only memory (ROM), rewritable non-volatile memory such as flash memory, hard drives, optical discs, and/or the like.

The network interface 24 may communicate data with another electronic device and/or a network. For example, the network interface 24 (e.g., a radio frequency system) may enable the electronic device 10 to communicatively couple to a personal area network (PAN), such as a Bluetooth network, a local area network (LAN), such as an 1622.11x Wi-Fi network, and/or a wide area network (WAN), such as a 4G or Long-Term Evolution (LTE) cellular network. The power source 26 may provide electrical power to one or more components in the electronic device 10, such as the processor core complex 18 and/or the electronic display 12. Thus, the power source 26 may include any suitable source of energy, such as a rechargeable lithium polymer (Li-poly) battery and/or an alternating current (AC) power converter. The I/O ports 16 may enable the electronic device 10 to interface with other electronic devices. For example, when a portable storage device is connected, the I/O port 16 may enable the processor core complex 18 to communicate data with the portable storage device. The input device 14 may enable user interaction with the electronic device 10, for example, by receiving user inputs via a button, a keyboard, a mouse, a trackpad, and/or the like. The input device 14 may include touch-sensing components in the electronic display 12. The touch-sensing components may receive user inputs by detecting occurrence and/or position of an object touching the surface of the electronic display 12.

In addition to enabling user inputs, the electronic display 12 may include one or more display panels. Each display panel may be a separate display device or one or more display panels may be combined into a same device. The electronic display 12 may control light emission from the display pixels to present visual representations of information, such as a graphical user interface (GUI) of an operating system, an application interface, a still image, or video content, by displaying frames based on corresponding image data. As depicted, the electronic display 12 is operably coupled to the processor core complex 18 and the image processing circuitry 28. In this manner, the electronic display 12 may display frames based on image data generated by the processor core complex 18 and/or the image processing circuitry 28. Additionally or alternatively, the electronic display 12 may display frames based on image data received via the network interface 24, an input device 14, an I/O port 16, or the like.

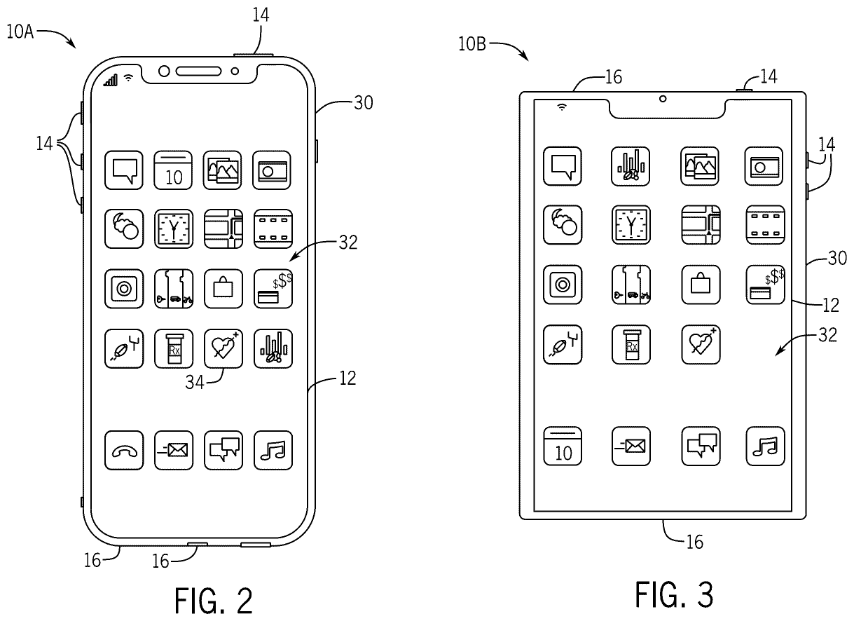

The electronic device 10 may take any suitable form. One example of the electronic device 10, a handheld device 10A, is shown in FIG. 2. The handheld device 10A may be a portable phone, a media player, a personal data organizer, a handheld game platform, and/or the like. For illustrative purposes, the handheld device 10A may be a smart phone, such as any IPHONE® model available from Apple Inc.

The handheld device 10A includes an enclosure 30 (e.g., housing). The enclosure 30 may protect interior components from physical damage and/or shield them from electromagnetic interference, such as by surrounding the electronic display 12. The electronic display 12 may display a graphical user interface (GUI) 32 having an array of icons. When an icon 34 is selected either by an input device 14 or a touch-sensing component of the electronic display 12, an application program may launch.

The input devices 14 may be accessed through openings in the enclosure 30. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes.

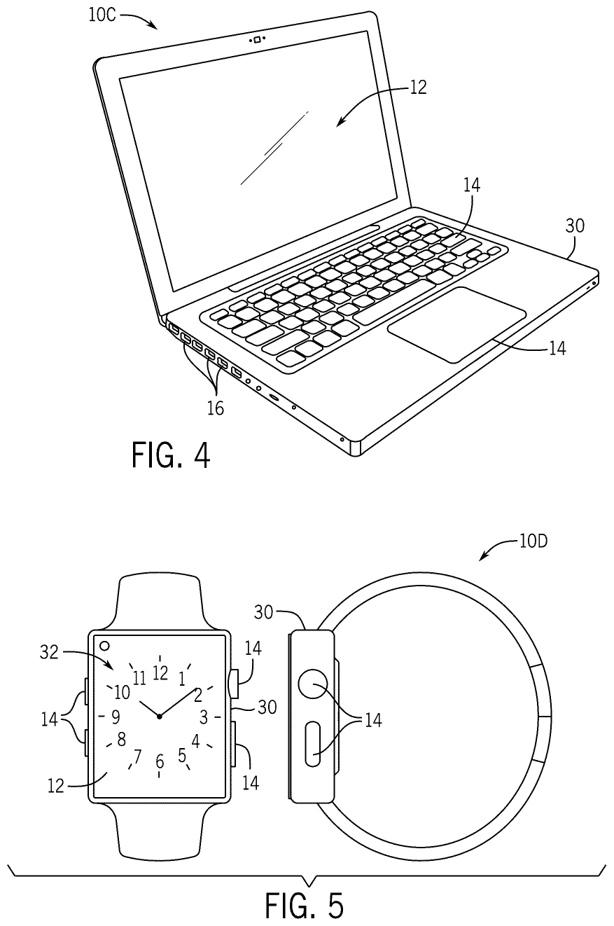

Another example of a suitable electronic device 10, specifically a tablet device 10B, is shown in FIG. 3. The tablet device 10B may be any IPAD® model available from Apple Inc. A further example of a suitable electronic device 10, specifically a computer 10C, is shown in FIG. 4. For illustrative purposes, the computer 10C may be any MACBOOK® or IMAC® model available from Apple Inc. Another example of a suitable electronic device 10, specifically a watch 10D, is shown in FIG. 5. For illustrative purposes, the watch 10D may be any APPLE WATCH® model available from Apple Inc. As depicted, the tablet device 10B, the computer 10C, and the watch 10D each also includes an electronic display 12, input devices 14, I/O ports 16, and an enclosure 30. The electronic display 12 may display a GUI 32. Here, the GUI 32 shows a visualization of a clock. When the visualization is selected either by the input device 14 or a touch-sensing component of the electronic display 12, an application program may launch, such as to transition the GUI 32 to presenting the icons 34 discussed with respect to FIGS. 2 and 3.

In an electronic device 10, the digital film grain generation and insertion may be implemented in a memory-to-memory scaler and rotator (MSR) hardware operations. The MSR hardware operations may be implemented to modify image data including pixel values to include generated digital film grain in an image or a video frame.

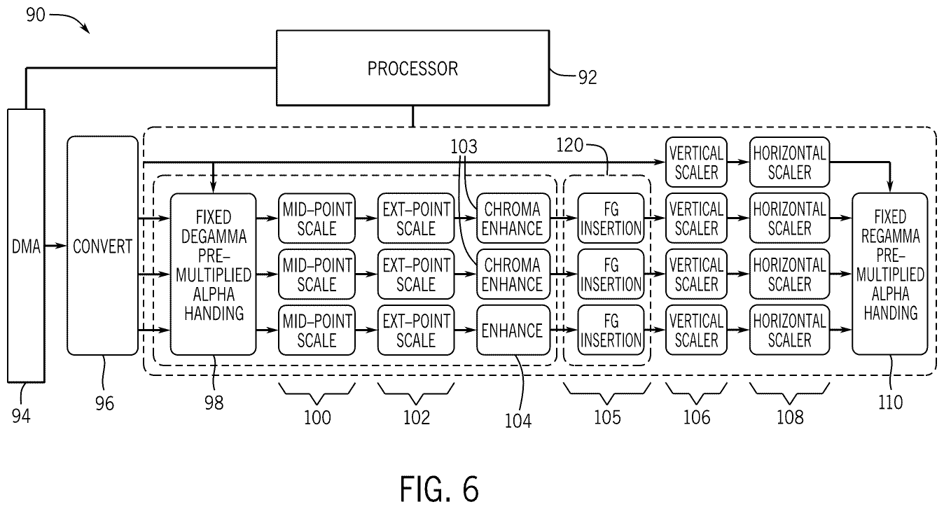

Keeping the foregoing in mind, FIG. 6 is a block diagram of memory-to-memory scaler and rotator (MSR) hardware 90 for image processing, in accordance with an embodiment. The MSR hardware 90 may include a MSR convert block 96, a de-gamma operation and pre-multiplied alpha handling block 98, multiple mid-point scaling blocks 100, multiple exterior point (ext-point) scaling blocks 102, multiple chroma enhance blocks 103, an enhance block 104, multiple film grain insertion blocks 105, multiple vertical scaler blocks 106, multiple horizontal scaler blocks 108, and a fixed re-gamma and pre-multiplied alpha handling block 110. The MSR hardware 90 may include directional scaler capabilities and enable scaling of pixel values received by the hardware.

The MSR hardware may include a processor 92 that may be a local co-processor of the MSR hardware and/or a main application processor. The processor 92 may be in communication with a direct memory access (DMA) of the MSR hardware 90. The MSR convert block 96 hardware may remap image data (e.g., RGB channels, alpha channel) received from the MSR DMA 94 from a source format to any suitable operating format (e.g., s7.24) prior to image processing operations being performed on the image data. The output of the convert block 96 is received by the fixed de-gamma pre-multiplied alpha handling block 98 which includes hardware that receives the RGB channels including pre-multiplied alpha content and ensures that fixed de-gamma operations are only applied to non-pre-multiplied alpha content when linear scaling mode is enabled. To ensure this, each of the RBG channels may be divided by the alpha channel of an alpha pre-multiplied input pixel. The alpha channel may be re-multiplied into each RGB channel to enable scaling operations to be performed on pre-multiplied alpha content.

The output of the re-multiplication of alpha by each of the RGB channels may be streamed to mid-point scale blocks 100 to begin scaler operations for each RGB channel. Each of the RGB channels may be received at a respective mid-point scale block 100. The mid-point scale block 100 may perform a two-times interpolation by interpolating the mid-point of every 2×2 pixel, or any other suitable number set of pixels, followed by interpolation of the exterior points at the ext-point scale blocks 102. Each of the chroma enhancement block 103 and the enhance block 104 receives the interpolated pixel values from each of the ext-point scale blocks 102, and performs enhancement to enhance image edges that may have been blurred during the directional scaling. The output of each chroma enhancement block 103 and the enhance block 104 may then be streamed into each of the film grain (FG) insertion blocks 105.

Each of the film grain insertion blocks 105 may fetch a film grain value from a programmable template of film grain values, scale the film grain value, and combine a scaled film grain value with pixel value of each component (e.g., R/Y component, G/Cb component, B/Cr component). Together, the three film grain insertion blocks 105 make up film grain insertion circuitry 120. The output of the film grain insertion blocks 105 may be sent to the vertical scaler blocks 106.

Each of the vertical scaler blocks 106 may include three filters and may use a first filter to scale RGB components and use another filter to scale the alpha components. The output of the vertical scaler blocks 106 may be sent to the horizontal scaler blocks 108. Similar to the vertical scaler blocks 106, the horizontal scaler blocks 108 may include three filters and may use a first filter to scale RGB components and use another filter to scale the alpha components. The output of each of the horizontal scaler blocks 108 corresponding to each RGB channel and alpha channel may be sent to the fixed re-gamma, pre-multiplied alpha handling block 110 that includes hardware to remove the pre-multiplied alpha content from each of the RGB channels prior to re-gamma operations.

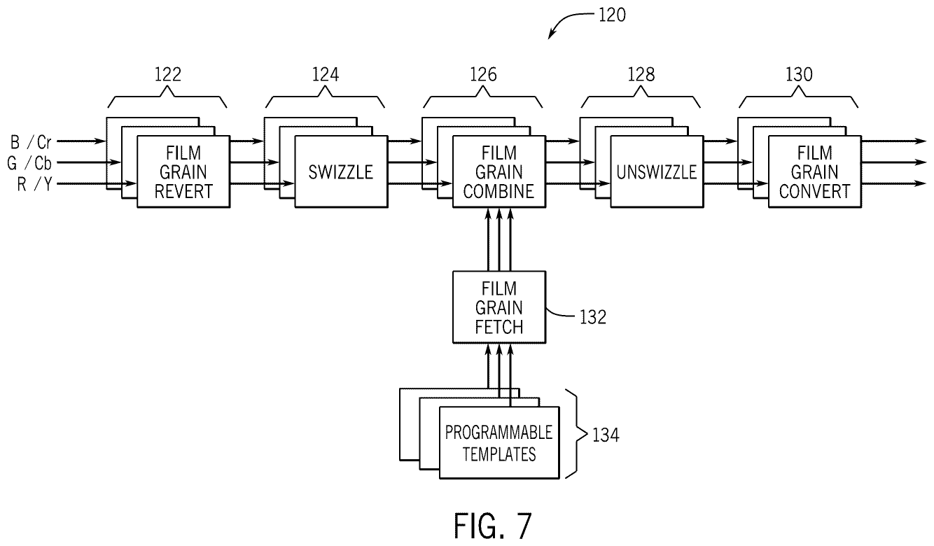

Keeping the foregoing in mind, FIG. 7 is a block diagram of the film grain insertion circuitry 120. The film grain insertion circuitry 120 may include a film grain revert blocks 122, a swizzle blocks 124, a film grain combine blocks 126, an unswizzle blocks 128, a film grain convert blocks 130, a film grain fetch blocks 132, and programmable templates 134. Each set of blocks (e.g., film grain revert blocks 122, swizzle blocks 124, film grain combine blocks 126, unswizzle blocks 128, film grain convert blocks 130, programmable templates 134) may contain three blocks, one for each channel.

The film grain revert blocks 122 and the film grain convert blocks 130 may convert image data to and from a certain format, respectively. In particular, the film grain revert blocks 122 may transform the input image data (e.g., data input to the film grain insertion circuitry 120) to a color space or data representation that is used by the MSR hardware 90 and/or the film grain insertion circuitry 120. For example, the film grain revert blocks 122 may change a bit depth of fixed point numbers in the image data to 24 bits. In another example, the film grain revert blocks 122 may change the color space of the input image data to YCbCr color space. As a last step before the image data is output from the film grain insertion circuitry 120, the film grain convert blocks 130 convert the image data to the original format of the input image data. The film grain revert blocks 122 and the film grain convert blocks 130 ensure that the film grain insertion circuitry 120 is compatible with a variety of data formats of other hardware components of the electronic device 10.

The swizzle blocks 124 and the unswizzle blocks 128 may reorder color channels to and from a color channel configuration that is compatible with the configuration of color channels in the film grain combine blocks 126. For example, the swizzle block 124 may map the luminance channel from one component to another component that is consistent with the luminance channel of the film grain combine blocks 126. The unswizzle blocks 128 may reorder the color channels of the image data back to the original configuration. That is, the unswizzle blocks 128 may undo the color channel reordering performed by the swizzle block 124. The swizzle block 124 and the unswizzle blocks 128 may ensure that the film grain combine blocks 126 are compatible with color channel configurations of other hardware components of the electronic device 10.

The film grain combine blocks 126 may add the film grain to the image data. In particular, the film grain combine blocks 126 may receive the film grain values fetched from the programmable templates 134 by the film grain fetch block 132. In addition, the film grain combine blocks 126 may scale the film grain values according to the intensity of the color components of the image. For example, the scaling operation may ensure that the intensity of the film grain values is consistent with the intensity of pixels of the image such that a bright image may have a bright film grain added and a dark image may have a dark film grain added. In an embodiment, the target intensity level of the scaled film grain values may be based on a non-uniform sampling of the luminance intensity levels of the color components the image. Finally, the film grain combine blocks 126 may combine the scaled film grain values with the pixel values.

The film grain fetch block 132 may retrieve unscaled film grain values from the programmable template 134. In particular, the film grain fetch block 132 may pseudo-randomly sample the programmable templates 134 based on a random offset that is generated by a linear feedback shift register (LFSR). The linear feedback shift register may use as an input the position of the image pixel and a random seed. Every time the LFSR advances, a new film grain value may be fetched from the programmable template 134. In an embodiment, the film grain value may be a 16-bit value.

Each programmable template 134 may be a comparatively small image (e.g., a 16×16 pixel, 32×32 pixel, 64×64 pixel, 128×128 pixel, or the like) image that captures the essence of the film grain that is to be added to the image. In particular, different programmable templates 134 may contain different film grain values. For example, the programmable template 134 may specify whether the film grain is fine or coarse. There may be a separate programmable template 134 for each color channel. In an embodiment, the programmable template 134 may be generated based on information obtained from the encoder. For example, when encoding an image or a video, the encoder may characterize the film grain and/or obtain the film grain parameters and the film grain. The image or a video may be encoded without the film grain (e.g., the image/video may be de-noised prior to encoding) to reduce the data rate needed to transport the encoded image or video. After decoding, the film grain may be added back to the image/video via the MSR hardware 90 based on the characteristics and/or parameters obtained from the encoder.

During encoding, image data is typically processed in a block-based (e.g., block by block) raster scan format and the film grain values in a programmable template 134 may be consistent with the raster format. However, MSR hardware 90 processes an image frame in vertical strips of limited rows of pixels. Thus, film grain values from the programmable template 134 may be accessed in a certain order consistent with the vertical processing of the image frame. In order to access the programmable template 134 in a proper order, a random process modeled by the LFSR may be fast-forwarded or reversed in order to properly match a pixel in the image frame with the corresponding LFSR iteration in a sequence of LFSR iterations.

The programmable templates 134 may be generated using any suitable technique. For example, the programmable templates 134 may be generated via a parametric method that involves fitting the film grain of a film grain sample to an autoregressive model and generating the programmable template 134 based the parameters of the model. Additionally or alternatively, the programmable templates 134 may be generated using a spectral method that involves synthesizing a programmable template 134 with a target spatial frequency spectrum and a target correlation structure.

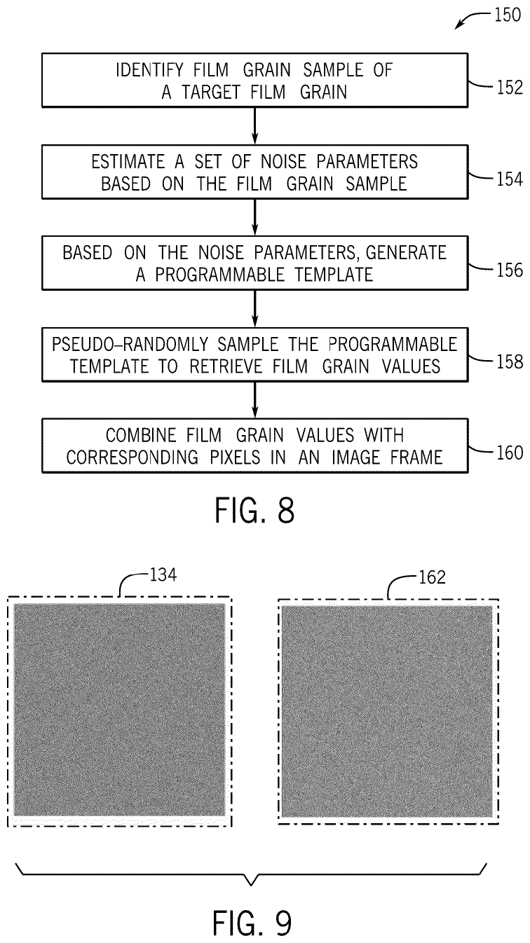

FIG. 8 is a flow diagram of a process 150 of generating a programmable template 134 via the parametric method and of sampling the programmable template 134 to retrieve the film grain value. At block 152, a film grain sample of a target film grain is identified. The film grain sample may be an image shot at a particular target ISO level and stored in the memory (e.g., local memory 20 and/or the main memory storage device 22) of the electronic device 10. At block 154, a set of noise parameters may be estimated based on the film grain sample. The film grain may be viewed as spatial noise in the pixel values of an image, which may be modeled by a random process such as an autoregressive—moving-average (ARMA) model. Thus, the film grain “pattern” may be encapsulated in a set of noise parameters associated with the model used to fully characterize the film grain (e.g., noise/fluctuations in pixel values) of the film grain sample. In particular, the set of noise parameters may be parameters (e.g., coefficients of a polynomial equation, coefficients of spatial linear prediction model) of a autoregressive model and/or parameters (e.g., coefficients of a polynomial equation) of a moving average model. For example, the set of noise coefficients may be a five by five array of 25 ARMA model. It may be appreciated that different film grain samples with different types of film grain “patterns” may have a different set of noise parameters. In an embodiment, the parameter generation may be performed only once and the sets of noise parameters for all film grain samples may be stored in a parameter library. In an embodiment, the parameter library may be uploaded to the electronic device and film grain sample selection (block 152) and noise parameter estimation (block 154) may be omitted from the process 150. In an additional or an alternative embodiment, the sets of noise parameters may be fetched from the parameter library based on the metadata from the camera of the electronic device 10. For example, the parameter library could be addressed by the ISO level fetched from the camera metadata. It may be appreciated that the camera of the electronic device may perform de-noising and encoding operations of the photos and videos captured by the camera and, therefore, parameters associated with noise of various ISO levels may be present in its metadata.

At block 156, based on the noise parameters, a noise template may be generated. For example, the model (e.g., ARMA model) with the noise parameters used as inputs may be iterated to generate film grain values that populate the programmable template 134. The programmable template 134 may be populated by the film grain values consecutively output by the model in a raster scan order. A different programmable template 134 may be generated for each color channel. Due to the autoregressive nature of the model, the value of each pixel may in part depend on the values of the previous pixels in the sequence. FIG. 9 is an illustration of a programmable template 134 generated via the parametric method and the corresponding film grain sample 162. One may appreciate that the programmable template 134 and the film grain sample 162 appear to have a similar film grain “pattern.”

Once the programmable templates 134 are generated, the film grain is applied to the image frame (e.g., an image or a frame of a video) in blocks of pixels. For example, the image frame may be divided into equal-sized square blocks of pixels (e.g., 16×16 pixel blocks, 32×32 pixel blocks, 64×64 pixel blocks, 128×128 pixel blocks). An LFSR output may be is determined for each pixel block based at least in part on the individual pixel values and/or position coordinates of each pixel in the pixel block and a pseudorandom seed for the image frame. The LFSR output may include pseudorandom offsets for sampling the programmable template 134 for every pixel in the pixel block. In an embodiment, the pseudorandom offset may include position coordinates (e.g., a row number and a column number) of a pixel in the programmable template 134. At block 158, the programmable template 134 is pseudo-randomly sampled to retrieve a film grain value. Sampling a programmable template 134 may include receiving a film grain value of a pixel located in a position on the programmable template 134 corresponding to a pseudorandom offset value, e.g., (x, y), generated from the current state of the LFSR. For example, if the pseudo random offset is (23, 45), then the film grain value found in the 23^{rd} column and 45^{th} row of a programmable template 134 may be retrieved. In an embodiment, a programmable template 134 may be sampled to fetch a film grain value for every pixel in a pixel block.

In block 160, the film grain value may be combined with the pixel value in the image frame. As discussed, combining the pixel value in the image frame with the film grain may a involve scaling (e.g., multiplying by a factor) the film grain value according to the intensity of the pixel values associated with a color channel. The scaling may be enabled by a lookup table that takes as input the film grain value (e.g., unscaled value from the programmable template 134) and outputs a scaled film grain value. Additionally or alternatively, combining the pixel value in the image frame with the film grain value may involve adding or multiplying the scaled film grain value to the pixel value.

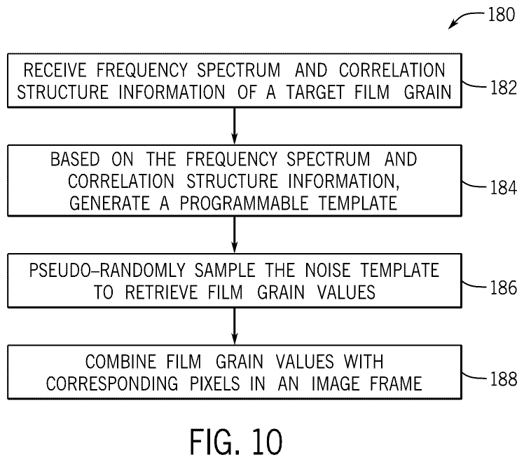

FIG. 10 is a flow diagram of a process 180 of generating a programmable template 134 via the spectral method and sampling the programmable template 134 to retrieve a film grain value. The spectral method involves generating a programmable template 134 based on known characteristics of the target film grain such as the spatial frequency spectrum and correlation structure of the target film grain. In block 182, a frequency spectrum and correlation structure information of a target film grain are received. The frequency spectrum of a film grain may indicate what spatial frequencies of pixel values are present in in the film grain. To determine the spatial frequency spectrum, a sample of the film grain may be transformed (e.g., via Fourier transformation) into the frequency domain. The various spatial frequency components of the sample may be identified to determine the spectrum of the target film grain. For example, a fine film grain (e.g., ISO 100) may include high spatial frequency components, whereas a coarse target film grain (ISO 1600) may include more lower-frequency components. The frequency spectrum may include all frequency components of the film grain sample. The correlation structure of the film grain may indicate the correlation between the pixel values in the film grain sample. For example, fine film grain may have low correlation or no correlation between values of neighboring pixels and, therefore, the fine film grain may have a narrow spatial correlation structure. On the other hand, in a coarse film grain sample, values of several neighboring pixels may be correlated and, therefore, coarse film grain may have a wider spatial correlation structure.

In block 184, a programmable template 134 is generated based on the frequency spectrum and the correlation structure information. For example, simulation that generates noise with a particular set of frequencies and correlation structure could be used to obtain film grain pixel values found in the programmable template 134. Additionally or alternatively, the frequency spectrum of target film grain may be transformed into the spatial domain and adjusted to include the target correlation structure.

Once the programmable templates 134 are generated, the film grain is applied to the image frame (e.g., an image or a frame of a video) in blocks of pixels such as 32×32 blocks of pixels, 64×64 blocks of pixels, 128×128 blocks of pixels, etc. An LFSR output may be determined for each pixel block based at least in part on the individual pixel values and/or position coordinates of each pixel in the pixel block and a pseudorandom seed for the image frame. The LFSR output may include pseudorandom offsets for sampling the programmable template 134 for every pixel in the pixel block. In an embodiment, the pseudorandom offset may include position coordinates (e.g., a row number and a column number) of a pixel in the programmable template 134. At block 186, the programmable template 134 is pseudo-randomly sampled to retrieve a film grain value. As discussed, sampling a programmable template 134 may include receiving a film grain value of a pixel that is located in a position on the programmable template 134 corresponding to a pseudorandom offset value, e.g., (x, y), generated from the current state of the LFSR. In an embodiment, a programmable template 134 may be sampled to fetch a film grain value for every pixel in a pixel block.

In block 188, the film grain value may be combined with the pixel value in the image frame. As discussed, combining the film grain value and the pixel value may involve scaling (e.g., multiplying by a factor) the film grain value according to the intensity of the pixel values associated with a color channel. The scaling may be performed by a lookup table that takes as input the unscaled film grain value from the programmable template 134 and outputs a scaled film grain value. In addition, combining the pixel value in the image frame with the film grain value may involve adding or multiplying the scaled film grain value to the pixel value.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. An electronic device comprising:
an electronic display configured to display an image based at least in part on processed image data; and
image processing circuitry configured to:
receive a film grain value from a film grain template;
perform scaling operations on the film grain value to produce a scaled film grain value; and
combine the scaled film grain value with a value of a pixel in an image frame of the image.

2. The electronic device of claim 1, wherein the image processing circuitry is configured to:
generate a plurality of offsets for a pixel block in the image frame based at least in part on a random seed for the pixel block, wherein each offset of the plurality of offsets comprises coordinates of film grain values in the film grain template.

3. The electronic device of claim 2, wherein the image processing circuitry is configured to:
identify the film grain value in the film grain template corresponding to an offset of the plurality of offsets, wherein the offset is based at least in part on coordinates of the pixel in the image frame.

4. The electronic device of claim 2, wherein the plurality of offsets are generated using a linear feedback shift register (LFSR).

5. The electronic device of claim 1, wherein the image processing circuitry is configured to:
receive a second film grain value from a second film grain template;
perform scaling operations on the second film grain value to produce a scaled second film grain value; and
add the scaled second film grain value to the value of a second pixel in the image frame.

6. The electronic device of claim 1, wherein the value comprises a luma value, a chroma value, or both.

7. The electronic device of claim 1, wherein the film grain template comprises film grain values generated based at least in part on film grain parameters received from an encoder.

8. The electronic device of claim 1, wherein performing the scaling operations comprises using a look-up-table (LUT) to multiply the film grain value by a scaling factor.

9. The electronic device of claim 1, wherein the image processing circuitry comprises memory-to-memory scaler and rotator (MSR) circuitry configured to perform scaling and rotation operations on the image data.

10. The electronic device of claim 1, wherein combining the scaled film grain value with the value of the pixel in the image frame of the image comprises adding the film grain value and the value of the pixel.

11. An electronic device comprising:
an electronic display configured to display an image based at least in part on processed image data; and
image processing circuitry configured to:
determine a set of parameters based on a film grain sample, wherein
the film grain sample comprises an image shot at a certain ISO level;
based on the set of parameters, generate a film grain template, wherein the film grain template comprises film grain values; and
pseudo-randomly sample the film grain template to fetch the film grain values.

12. The electronic device of claim 11, wherein the set of parameters comprises parameters of an autoregressive moving average (ARMA) model that characterizes spatial noise in pixel values of the film grain sample.

13. The electronic device of claim 11, wherein the set of parameters is received from metadata of a camera of the electronic device.

14. The electronic device of claim 11, wherein the image processing circuitry is configured to:
determine a second set of parameters based on a second film grain sample, wherein the second set of parameters and the set of parameters are stored in a parameter library.

15. The electronic device of claim 14, wherein the image processing circuitry is configured to:
receive the second set of parameters from the parameter library; and
based on the second set of parameters, generate a second film grain template.

16. The electronic device of claim 11, wherein generating the film grain template comprises filling the film grain template in a raster scan order with the film grain values consecutively generated by an autoregressive model for the set of parameters.

17. One or more tangible, non-transitory, computer-readable media, comprising instructions that cause pixel contrast control processing circuitry of an electronic device to:
receive a spatial frequency spectrum and spatial correlation structure information of a target film grain;
based on the frequency spectrum and correlation structure information, generate a film grain template; and
pseudo-randomly sample the film grain template to fetch film grain values.

18. The one or more tangible, non-transitory, computer-readable media of claim 17, wherein the instructions that cause the processing circuitry to pseudo-randomly sample the film grain template to fetch the film grain values comprise generating offset coordinates based at least in part on a pseudo-random seed and accessing the film grain values in the film grain template that correspond to the offset coordinates.

19. The one or more tangible, non-transitory, computer-readable media of claim 17, wherein the instructions that cause the processing circuitry to generate the film grain template comprise generating film grain values that, when arranged in a raster scan order, have the spatial frequency spectrum and the spatial correlation structure information of the target film grain.

20. The one or more tangible, non-transitory, computer-readable media of claim 17, wherein, based on the film grain being a fine film grain, the spatial frequency spectrum comprises higher spatial frequencies and the correlation structure information indicates narrower correlation structure.
